(19) United States
(12) Patent Application Publication
(10) Pub. No.: US 2023/0335351 A1
(43) Pub. Date: Oct. 19, 2023

(54) METER SWITCH GUARD

(71) Applicant: E.J. Brooks Company d.b.a. Brooks Utility Products Group, Novi, MI (US)

(72) Inventors: Justin Olson, Flat Rock, MI (US); Bryce Hudson, Metamora, MI (US)

(21) Appl. No.: 17/723,791

(22) Filed: Apr. 19, 2022

(51) Int. Cl. H01H 9/02

(52) U.S. Cl. CPC H01H 9/02

(57) ABSTRACT

A method of insulating an electrical switch includes forming a switch cover having a front wall, a first side wall, a second side wall, a top wall, and an open bottom opposite the top wall by folding a sheet of electrically insulating material. The method includes placing the switch cover over a component of the electrical switch, the component extending into the switch cover through the open bottom.

### BACKGROUND

Buildings and other structures are typically electrically connected to an electrical grid that delivers power from a utility power source to the building. The utility power source may be, for example, a coal plant, a nuclear plant, a hydro-electric dam, a solar farm, a wind farm, etc. An electrical meter is installed at an electrical connection of the building to the electrical grid. The electrical meter, also known as a watthour meter, measures an amount electrical power consumed at the build and supplied via the electrical grid. The amount of electrical power measured electrical power may be used to determine how much a consumer should be billed by an operator of the utility power source.

A switch block having a plurality of switches moveable between open and closed positions that provide open and closed electrical circuits may be connected to the electrical grid, the meter, and/or electrical loads of the building. Various switches of the switch block may be placed in the open position and other switches of the switch block may be placed in the closed position, e.g., to open a circuit connected to the electrical grid and to close one or more circuits connected to the meter and the electrical loads. Such configuration may inhibit power from the electrical grid from flowing to the meter and electrical loads, while permitting testing of the meter and/or any electrical device such as a current transformer or voltage transformer that is connected, to ensure proper measure of electrical power consumed by the electrical loads.

### BRIEF DESCRIPTION OF THE DRAWINGS

FIG. 1 is a perspective view of a switch block assembly and a switch cover with an extension wall folded outside of the switch cover.

FIG. 2 is a side view of the switch block assembly and the switch cover with the extension wall folded outside of the switch cover.

FIG. 3 is a perspective view of the switch cover with the extension wall folded outside of the switch cover.

FIG. 4 is a front view of the switch cover with the extension wall folded outside of the switch cover.

FIG. 5 is a rear view of the switch cover with the extension wall folded outside of the switch cover.

FIG. 6 is a right-side view of the switch cover with the extension wall folded outside of the switch cover.

FIG. 7 is a left-side view of the switch cover with the extension wall folded outside of the switch cover.

FIG. 8 is a top view of the switch cover with the extension wall folded outside of the switch cover.

FIG. 9 is a bottom view of the switch cover with the extension wall folded outside of the switch cover.

FIG. 10 is a perspective view of the switch block assembly and the switch cover with the extension wall folded inside of the switch cover.

FIG. 11 is a side view of the switch block assembly and the switch cover with the extension wall folded inside of the switch cover.

FIG. 12 is a perspective view of the switch cover with the extension wall folded inside of the switch cover.

FIG. 13 is a front view of the switch cover with the extension wall folded inside of the switch cover.

FIG. 14 is a rear view of the switch cover with the extension wall folded inside of the switch cover.

FIG. 15 is a right-side view of the switch cover with the extension wall folded inside of the switch cover.

FIG. 16 is a left-side view of the switch cover with the extension wall folded inside of the switch cover.

FIG. 17 is a top view of the switch cover with the extension wall folded inside of the switch cover.

FIG. 18 is a bottom view of the switch cover with the extension wall folded inside of the switch cover.

FIG. 19 is a planar view of a sheet of electrically insulating material for forming the switch cover.

FIG. 20 is a flow chart illustrating a method of forming the switch cover from the sheet.

### DETAILED DESCRIPTION

An assembly includes a switch block assembly having a plurality of switches. The assembly includes a switch cover formed from a folded sheet of electrically insulating material and supported by the switch block assembly, the switch cover enclosing a component of one of the switches.

The one of the switches may include jaws and the switch cover may include an extension wall disposed within the jaws.

The switch cover may define a cavity, the component of one of the switches may include a toggle arm within the cavity, and the extension wall may be disposed within the jaws outside the cavity.

A method of insulating an electrical switch includes forming a switch cover having a front wall, a first side wall, a second side wall, a top wall, and an open bottom opposite the top wall by folding a sheet of electrically insulating material. The method includes placing the switch cover over a component of the electrical switch, the component extending into the switch cover through the open bottom.

The folding the sheet of electrically insulating material into the switch cover may include folding the sheet along a plurality of pre-formed fold lines.

The plurality of pre-formed fold lines may each include one of a perforated line, a scored line, or a crimped line.

The switch cover formed by folding the sheet of electrically insulating material may include an extension wall extending from the front wall.

The extension wall may extend inwardly from the front wall.

The extension wall may extend outwardly from the front wall.

The method may include placing the extension wall between jaws of the electrical switch.

The extension wall may extend upward beyond the top wall.

The extension wall may include a bottom edge and the front wall may include a bottom edge vertically spaced from the bottom edge of the extension wall.

The top wall may include a first panel extending from the first side wall toward the second wall and a second panel extending from the second side wall toward the first side wall.

The first panel may include a first engagement feature and the second panel may include a second engagement feature.

The forming the switch cover may include engaging the first engagement feature with the second engagement feature.

The first engagement feature may include a tab and the second engagement feature may include a slot.

Forming the switch cover may include disposing the tab of the first engagement feature into the slot of the second engagement feature.

The sheet of electrically insulating material may include a top edge, a bottom edge, a first pre-formed fold line extending from the top edge to the bottom edge and a second pre-formed fold line extending from the top edge to the bottom edge.

The sheet of electrically insulating material may include a right edge, a left edge, a third pre-formed fold line extending from the left edge to the first pre-formed fold line, and a fourth pre-formed fold line extending from the right edge to the second pre-formed fold line.

The sheet of electrically insulating material may include a fifth pre-formed fold line, a sixth pre-formed fold line, and a seventh pre-formed fold line, all extending from the top edge to the bottom edge and between the first pre-formed fold line and the second pre-formed fold line.

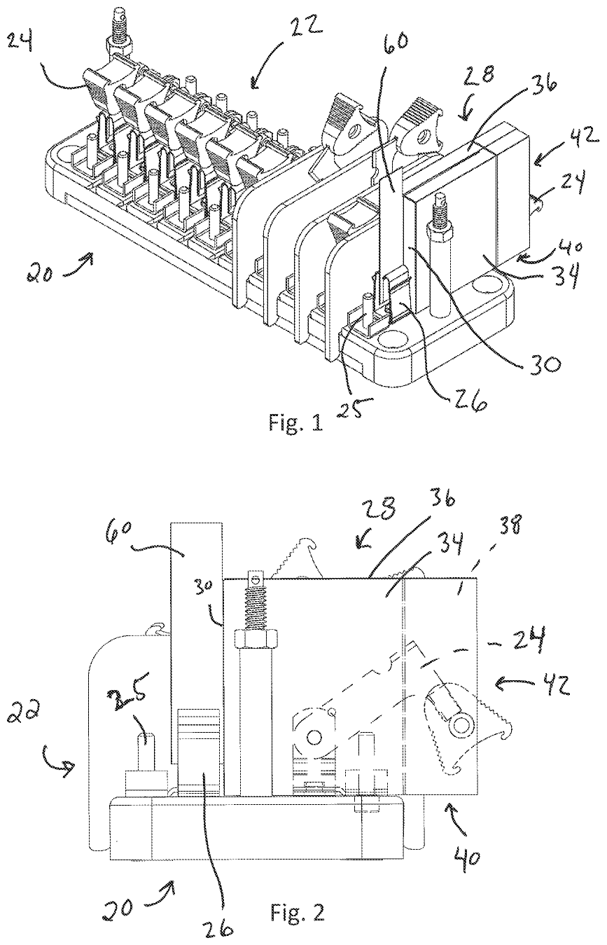

With reference to FIGS. 1, 2, 10 and 11, wherein like numerals indicate like elements thought the several view, a switch block assembly 20 having a plurality of switches 22 is shown. The switch block assembly 20 may be connected to one or more power sources (e.g., an electrical utility grid, a solar panel, a power wall, a generator, etc.), one or more electrical meters, one or more load centers, etc. (not shown). The switches 22 may open and close one or more electrical circuits that include the various elements connected to the switch block assembly 20. Each of the switches 22 is moveable from an open position to a closed position, and vice versa. The switch 22 in the open position inhibits flow of electricity, e.g., from one electrical connection of the switch 22 to another. The switch 22 in the closed position permits flow of electricity. For example, the switch 22 may include a toggle arm 24 connected to one electrical connection of the switch 22 and jaws 26 connected another electrical connection. The toggle arm 24 and the jaws 26 include an electrically conductive material. The toggle arm 24 may rotate about a pivot from the open position to the closed position, and vice versa. The toggle arm 24 in the open position may be spaced from, and not in physical contact with, the jaws 26. The toggle arm 24 in the closed position may be disposed between, and in physical contact with, the jaws 26. The switch 22 may include any other suitable structure, i.e., to open and closed the various electrical circuits connected to the switch block assembly 20. The switch 22 may include a connection post 25 to enable connection of electrical equipment to the switch 22. The connection post 25 may be in electrical communication with the jaws 26 and/or the toggle arm 24, i.e., such that electrical power can flow therebetween.

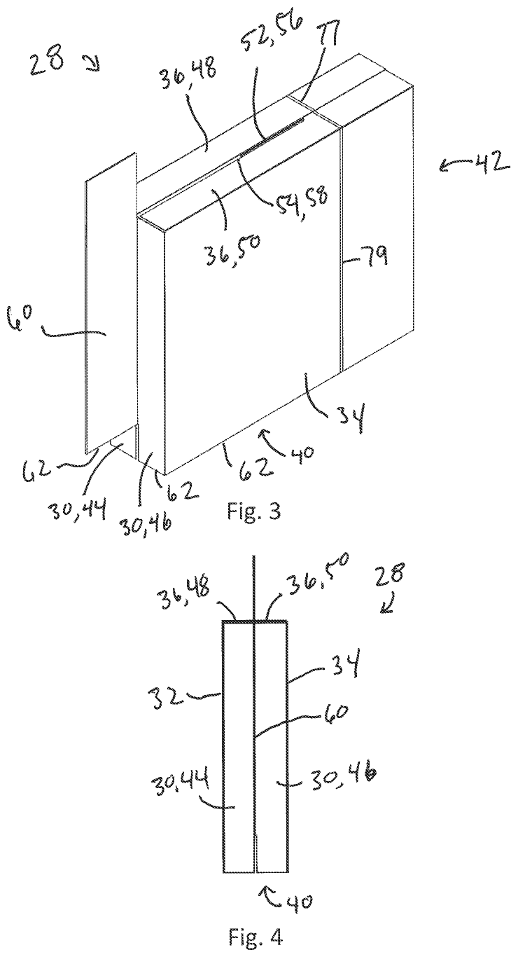

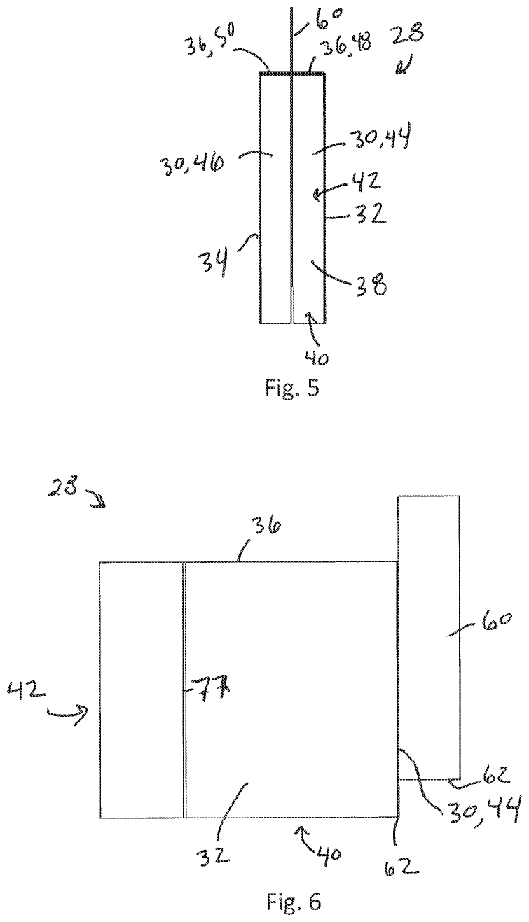

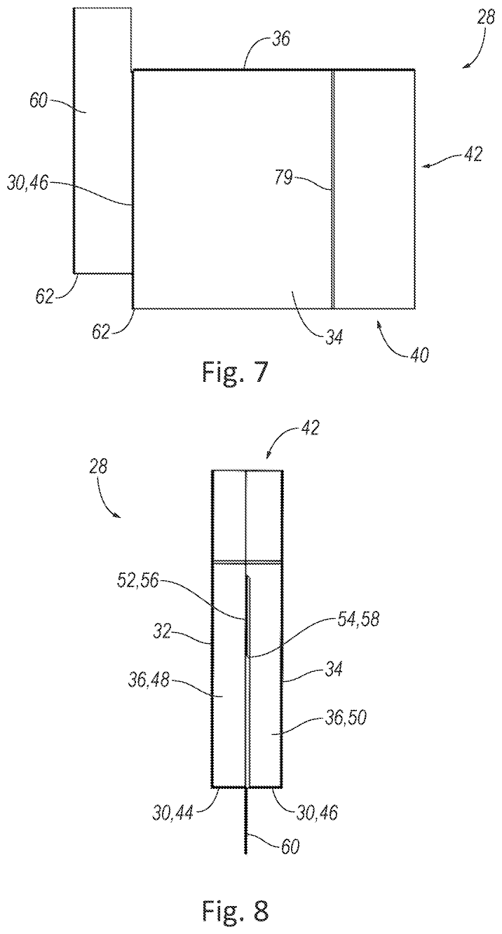

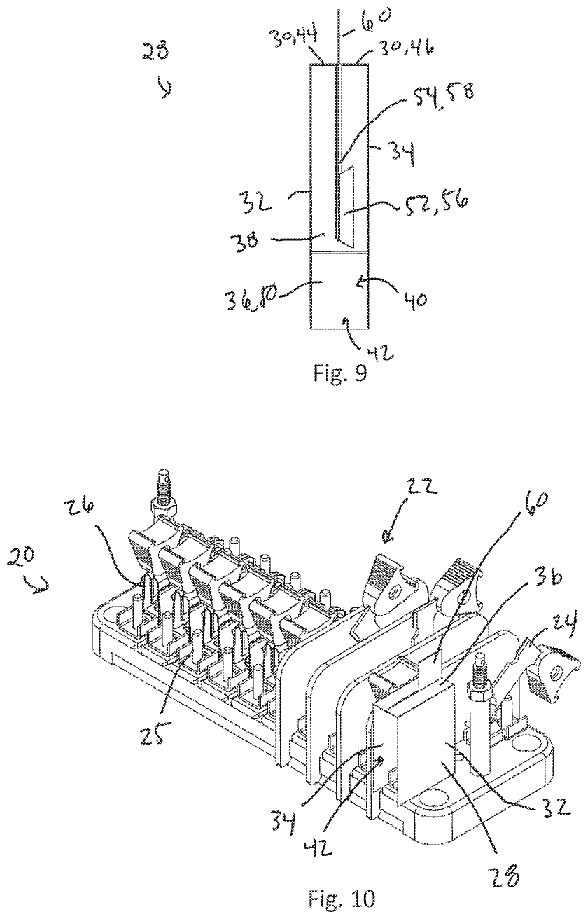

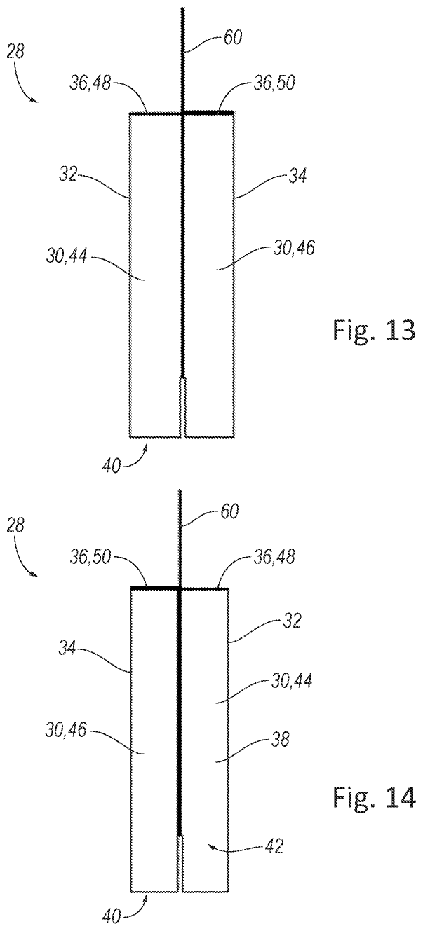

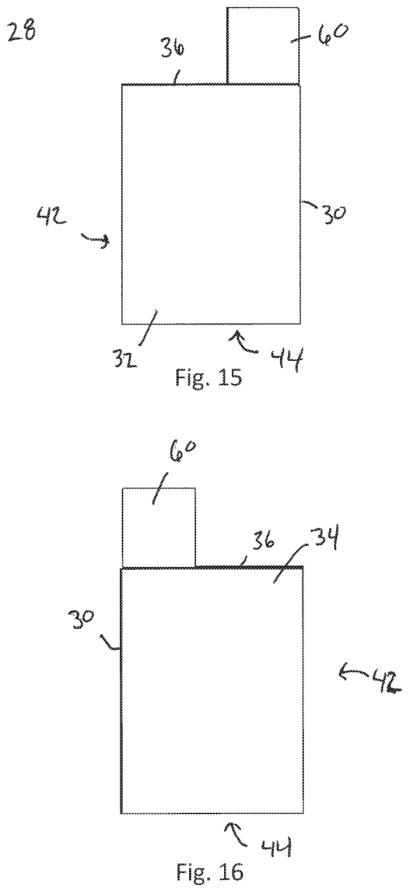

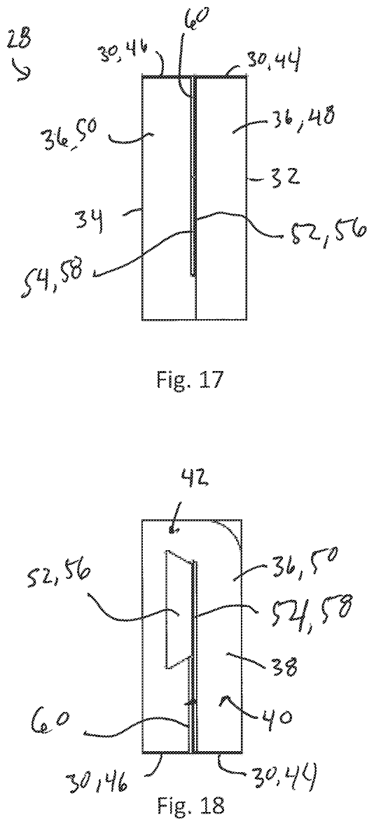

A switch cover 28, shown in FIGS. 1-18, electrically insulates components, such as the toggle arm 24, the connection post 25, and/or the jaws 26, of at least one of the electrical switches 22. For example, the switch cover 28 may prevent physical contact between components of the switch 22 and an operator actuating the switches 22. As another example, the switch cover 28 may inhibit moment of the switch 22 to the closed position. The switch cover 28 formed from a folded sheet 64 of electrically insulating material, e.g., as described below.

The switch cover 28 may include a front wall 30, a first side wall 32, a second side wall 34, and a top wall 36. The front wall 30, the first side wall 32, and the second side wall 34 may extend downward from the top wall 36. The top wall 36, the first side wall 32 and the second side wall 34 may extend rearward from the front wall 30. The switch cover 28 defines a cavity 38, e.g., between the first side wall 32 and the second side wall 34. The front wall 30 and the top wall 36 enclose a front and a top of the cavity 38. The switch cover 28 may include an open bottom 40 opposite the top wall 36. The switch cover 28 may include an open rear 42 opposite the front wall 30. The open bottom 40 and the open rear 42 may be between the first side wall 32 and the second side wall 34. Components of the switch 22 may be placed within the cavity 38 via the open bottom 40 and the open rear 42.

The front wall 30 may include a first panel 44 extending from the first side wall 32 toward the second side wall 34. The first panel 44 may extend generally halfway to the second side wall 34. The front wall 30 may include a second panel 46 extending from the second side wall 34 toward the first side wall 32. The second panel 46 may extend generally halfway to the first side wall 32. Distal ends of the first panel 44 and the second panel 46 may abut each other. The first panel 44 and the second panel 46 of the front wall 30 may be free from overlapping each other.

The top wall 36 may include a first panel 48 extending from the first side wall 32 toward the second side wall 34. The first panel 48 may extend over halfway to the second side wall 34. The first panel 48 may extend to the second side wall 34. The top wall 36 may include a second panel 50 extending from the second side wall 34 toward the first side wall 32. The second panel 50 may extend not all the way, e.g., halfway, to the first side wall 32. The first panel 48 and the second panel 50 may engage, e.g., couple, each other to collectively provide the top wall 36. For example, the first panel 48 may include a first engagement feature 52 and the second panel 50 may include a second engagement feature 54. The first engagement feature 52 and the second engagement feature 54 are engageable with each other. The first engagement feature 52 may include a tab 56 and the second engagement feature 54 may include a slot 58. The tab 56 may be disposed with the slot 58 to engage the first engagement feature 52 with the second engagement feature 54. The first engagement feature 52 and the second engagement feature 54 may include any suitable structure for coupling the first panel 48 and the second panel 50 together.

The switch cover 28 may include an extension wall 60 extending from the front wall 30. The extension wall 60 may extend from the distal ends of the first panel 44 and the second panel 46 of the front wall 30. The extension wall 60 may extend transversely, e.g., perpendicular, from the front wall 30. The extension wall 60 may extend upward from a bottom edge 62 beyond the top wall 36. In other words, the extension wall 60 may extend above the top wall 36. The bottom edge 62 at the extension wall 60 may be vertically spaced from the bottom edge 62 at the front wall 30 and/or at the first side wall 32 and the second side wall 34. For example, the bottom edge 62 at the extension wall 60 may be above the bottom edge 62 at the front wall 30 and the first side wall 32 and the second side wall 34. The extension wall 60 may extend outwardly from the front wall 30, as shown in FIGS. 1-9. For example, the extension wall 60 may extend from the front wall 30 and away from the cavity 38. The extension wall 60 may extend inwardly from the front wall 30, as shown in FIGS. 10-18. For example, the extension wall 60 may extend from the front wall 30 and into the cavity 38.

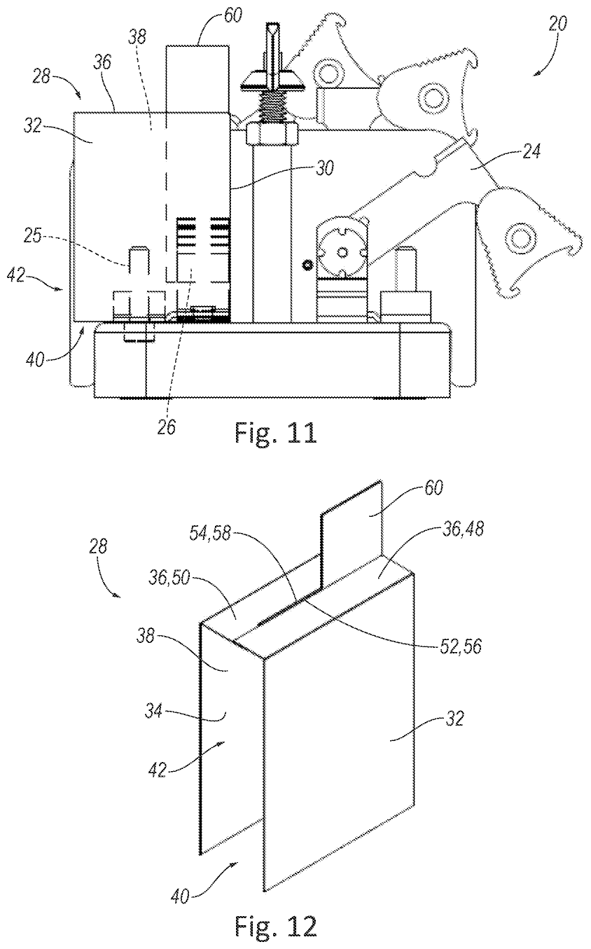

The switch cover 28 may be supported by the switch block assembly 20, insulating at least one of the switches 22. The switch cover 28 may enclose a component of one of the switches 22, such as the toggle arm 24, the connection post 25, and/or the jaws 26 within the cavity 38. The component of the switch 22, e.g., the toggle arm 24 and/or the jaws 26, may extend into the cavity 38 of the switch cover 28 through the open bottom 40 and/or open rear 42. In other words, the component of the switch 22 may extend from below and/or behind the first side wall 32 and the second side wall 34 upward and/or forward to between the first side wall 32 and the second side wall 34. The extension wall 60 may be disposed between jaws 26 of the electrical switch 22. Force applied to opposite sides of the extension wall 60 by the jaws 26 may secure the switch cover 28 to the switch 22. With reference to FIGS. 1 and 2, the extension wall 60 disposed within the jaws 26 may be outside the cavity 38. With reference to FIGS. 10 and 11, the extension wall 60 disposed within the jaws 26 may be inside the cavity 38.

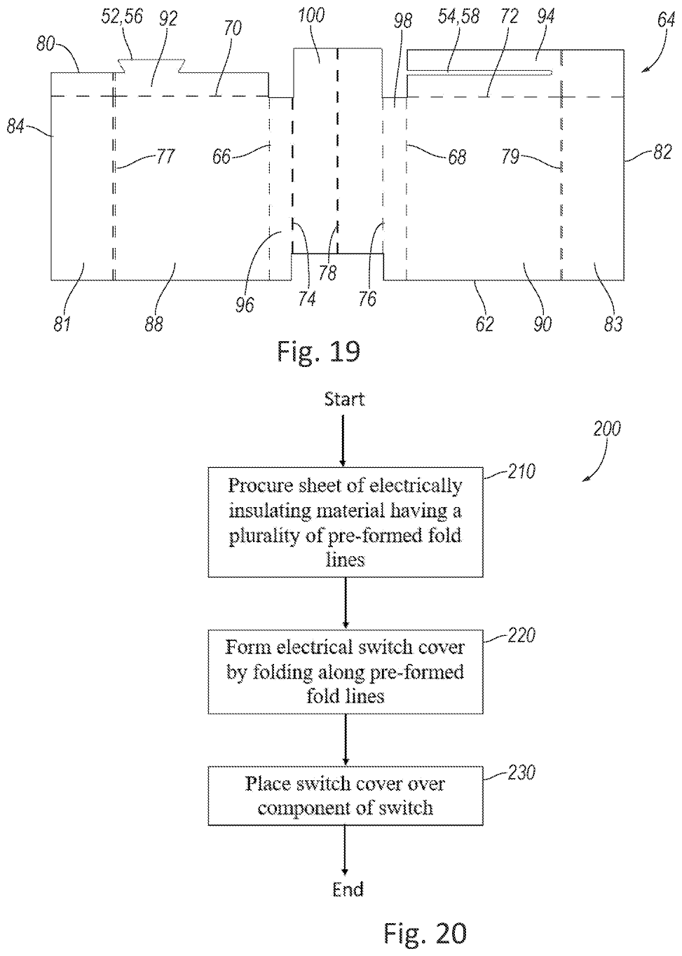

With refence to FIG. 19, an exemplary sheet 64 of electrically insulating material for forming the switch cover 28 is shown. The sheet 64 may be formed into the switch cover 28 by folding the sheet 64, e.g., along a plurality of pre-formed fold lines 66, 68, 70, 72, 74, 76, 78 and as further described below. The electrically insulating material does not conduct electricity. For example, the sheet 64 may be plastic, foam board, paper, or any other suitable material. The sheet 64 may include multiple layers of material. The fold lines 66, 68, 70, 72, 74, 76, 78 promote deformation there along, e.g., such that a bending force applied to the sheet 64 folds the sheet 64 along the fold lines 66, 68, 70, 72, 74, 76, 78. The sheet 64 at the fold lines 66, 68, 70, 72, 74, 76, 78 may be less ridged than adjacent the fold lines 66, 68, 70, 72, 74, 76, 78. For example, the pre-formed fold lines 66, 68, 70, 72, 74, 76, 78 may include at least one of a perforated line, a scored line, or a crimped line extending along the sheet 64. The perforated line may include plurality of holes extending part way, or all the way, through the sheet 64, and the holes may be spaced from each other along the fold line. The score line may extend part way, but not all the way through the sheet 64, the score line may be continuous along the fold line. The crimped line may be compressed continuously along the fold line, e.g., via folding the sheet 64 with or pressing the sheet 64 with a stamp.

The sheet 64 of electrically insulating material includes a top edge 80 and the bottom edge 62 spaced from the top edge 80. The sheet 64 of electrically insulating material includes a right edge 82 and a left edge 84 spaced from the right edge 82. The top edge 80 and the bottom edge 62 may both extend from the right edge 82 to the left edge 84. The right edge 82 and the left edge 84 may both extend from the top edge 80 to the bottom edge 62. The top edge 80 and the bottom edge 62 may include various curves, cusps, and various angled and linear portions. The right edge 82 and the left edge 84 may extend laterally from the top edge 80 to the bottom edge 62, e.g., without and various curves, cusps, and various angled and linear portions therebetween.

The sheet 64 may include a first pre-formed fold line 66 extending from the top edge 80 to the bottom edge 62. A portion 88 of the sheet 64 that provides the first side wall 32 may be between the left edge 84 and the first pre-formed fold line 66. The sheet 64 may include a second pre-formed fold line 68 extending from the top edge 80 to the bottom edge 62. A portion 90 of the sheet 64 that provides the second side wall 34 may be between the right edge 82 and the second pre-formed fold line 68.

The sheet 64 may include a third pre-formed fold line 70 extending from the left edge 84 to the first pre-formed fold line 66. The third pre-formed fold line 70 may be perpendicular to the first pre-formed fold line 66. The portion of the sheet 64 that provides the first side wall 32 may be between the third pre-formed fold line 70 and the bottom edge 62. A portion 92 of the sheet 64 that provides the first panel 48 of the top wall 36 may be between the third pre-fold line and the top edge 80. The sheet 64 may include a fourth pre-formed fold line 72 extending from the right edge 82 to the second pre-formed fold line 68. The fourth pre-formed fold line 72 may be perpendicular to the second pre-formed fold line 68. The portion of the sheet 64 that provides the second side wall 34 may be between the fourth pre-formed fold line 72 and the bottom edge 62. A portion 94 of the sheet 64 that provides the second panel 50 of the top wall 36 may be between the fourth pre-fold line and the top edge 80.

The sheet 64 of electrically insulating material may include a fifth pre-formed fold line 74, a sixth pre-formed fold line 76, and a seventh pre-formed fold line 78, all extending from the top edge 80 to the bottom edge 62 and between the first pre-formed fold line 66 and the second pre-formed fold line 68. The fifth pre-formed fold line 74 may be between the first pre-formed fold line 66 and the seventh pre-formed fold line 78. The sixth pre-formed fold line 76 may be between the second pre-formed fold line 68 and the seventh pre-formed fold line 78. The first pre-formed fold line 66, the second pre-formed fold line 68, the fifth pre-formed fold line 74, the sixth pre-formed fold line 76, and the seven pre-formed fold line may be parallel with each other.

A portion 96 of the sheet 64 that provides the first panel 44 of the front wall 30 may be between the first pre-formed fold line 66 and the fifth pre-formed fold line 74. A portion 98 of the sheet 64 that provides the second panel 46 of the front wall 30 may be between the second pre-formed fold line 68 and the sixth pre-formed fold line 76. A portion 100 of the sheet 64 that provides the extension wall 60 may be between the fifth pre-formed fold line 74 and the sixth pre-formed fold line 76. A distal edge of the extension wall 60 may be provided by the seventh pre-formed fold line 78.

The top edge 80 of the sheet 64 between the fifth pre-formed fold line 74 and the sixth pre-formed fold line 76 may be spaced from the top edge 80 between the first pre-formed fold line 66 and the fifth pre-formed fold line 74 and the top edge 80 between the second pre-formed fold line 68 and the sixth pre-formed fold line 76. For example, the sheet 64 between the fifth pre-formed fold line 74 and the sixth pre-formed fold line 76 may extend away from the bottom edge 62 beyond the top edge 80 between the first pre-formed fold line 66 and the fifth pre-formed fold line 74 and the top edge 80 between the second pre-formed fold line 68 and the sixth pre-formed fold line 76.

The top edge 80 of the sheet 64 between the left edge 84 and the first pre-formed fold line 66 and between the right edge 82 and the second pre-formed fold line 68 may be spaced from the top edge 80 between the first pre-formed fold line 66 and the fifth pre-formed fold line 74 and the top edge 80 between the second pre-formed fold line 68 and the sixth pre-formed fold line 76. For example, the sheet 64 between the left edge 84 and the first pre-formed fold line 66 and between the right edge 82 and the second pre-formed fold line 68 may extend away from the bottom edge 62 beyond the top edge 80 between the first pre-formed fold line 66 and the fifth pre-formed fold line 74 and the top edge 80 between the second pre-formed fold line 68 and the sixth pre-formed fold line 76.

The bottom edge 62 between the left edge 84 and the fifth pre-formed fold line 74 and between the right edge 82 and the sixth pre-formed fold line 76 may be spaced from the bottom edge 62 between the fifth and the sixth pre-formed fold line 76. For example, the sheet 64 between the left edge 84 and the fifth pre-formed fold line 74 and between the right edge 82 and the sixth pre-formed fold line 76 may extend away from the top edge 80 beyond the bottom edge 62 between the fifth and the sixth pre-formed fold line 76.

The sheet 64 of electrically insulating material may include a first tear line 77 and a second tear line 79 extending from the top edge 80 to the bottom edge 62. The first tear line 77 may be between the first pre-formed fold line 66 and the left edge 84. The second tear line 79 may be between the second pre-formed fold line 68 and the right edge 82. The first tear line 77 and the second tear line 79 promote separation (e.g., tearing) there along, e.g., such that a force applied to the sheet 64 separates the sheet 64 along first tear line 77 and the second tear line 79. The sheet 64 at the first tear line 77 and the second tear line 79 may be weaker than adjacent the first tear line 77 and the second tear line 79. For example, the first tear line 77 and the second tear line 79 may include at least one of a perforated line, a scored line, or a crimped line extending along the sheet 64. Tearing along the first tear line 77 and the second tear line 79 may removed a portion 81 and a portion 83 of the sheet 64, e.g., to decrease the length of the switch cover 28 formed from the sheet 64.

With reference to FIG. 20, a method 200 of insulating at least one electrical switch 22 of the switch block assembly 20 is shown. The method 200 begins at a block 210 where the sheet 64 of electrically insulating material is procured. The sheet 64 may be as described herein, e.g., including the various pre-formed fold lines 66, 68, 70, 72, 74, 76, 78 and the first tear line 77 and the second tear line 79. The sheet 64 may be procured from among a plurality of sheets 64. The sheets 64 may be, for example, stored in a common packaging and in a stacked arrangement.

Next, at a block 220 the sheet 64 formed into the switch cover 28 by folding the sheet 64 along the various pre-formed fold lines 66, 68, 70, 72, 74, 76, 78. For example, the sheet may be physically manipulated to bend the sheet 64 along the various pre-formed fold lines 66, 68, 70, 72, 74, 76, 78. The sheet 64 may first be folded along the seventh pre-formed fold line 78 to provide the extension wall 60 of the switch cover 28. The sheet 64 may then be folded along the fifth pre-formed fold line 74 and the sixth pre-formed fold line 76 to provide the front wall 30. The sheet 64 at the fifth pre-formed fold line 74 and the at the sixth pre-formed fold line 76 may be folded in opposite directions, e.g., with the first panel 44 of the front wall 30 extending from the extension wall 60 away from the second panel 46 of the front wall 30 and the second panel 46 of the front wall 30 extending from the extension wall 60 away from the first panel 44 of the front wall 30. The sheet 64 may also be folded along the first pre-formed fold line 66 and the second pre-formed fold line 68 to form the first side wall 32 and the second side wall 34 of the switch cover 28. The first pre-formed fold line 66 may be folded in a same direction as the fifth pre-formed fold line 74, and the second pre-formed fold line 68 may be folded in a same direction as the sixth pre-formed fold line 76 to form the switch cover 28 with the extension wall 60 within the cavity 38. The first pre-formed fold line 66 may be folded in an opposite direction as the fifth pre-formed fold line 74, and the second pre-formed fold line 68 may be folded in an opposite direction as the sixth pre-formed fold line 76 to form the switch cover 28 with the extension wall 60 outside the cavity 38. The sheet 64 may be folded along the third pre-formed fold line 70 to form the first panel 48 of the top wall 36 and may be folded along the fourth pre-formed fold line 72 to form the second panel 50 of the top wall 36. Formation of the switch cover 28 may be completed by engaging the first engagement feature 52 of the first panel 48 of the top wall 36 with the second engagement feature 54 of the second panel 50 of the top wall 36. For example, the tab 56 may be inserted into and disposed within the slot 58. Once the switch 22 is formed, spacing between the bottom edge 62 between to left edge 84 and the first pre-formed fold line 66 and the bottom edge 62 between the right edge 82 and the second pre-formed fold line 68 may provide the open bottom 40 of the switch cover 28. Spacing between the left edge 84 and the right edge 82 may provide the open rear 42 end. The switch cover 28 may be formed by folding the sheet 64 in an order other than as described. Additionally at the block 230 the sheet 64 may be torn along the first tear line 77 and the second tear line 79 to remove the portion 81 and the portion 83 from the sheet 64 to decrease the length of the switch cover 28.

At a block 230, after the switch cover 28 is formed from the sheet 64, the switch cover 28 is placed over a component of the switch 22, the component may extend in into the switch cover 28 through the open bottom 40. For example, as shown in FIGS. 1 and 2, the toggle arm 24 may extend into of the cavity 38 via the open bottom 40 and out of the cavity 38 via the open rear 42. As another example, as shown in FIGS. 10 and 11, the connection post 25 and the jaws 26 may extend into the cavity 38 via the open bottom 40. Additionally, the extension wall 60 may be placed between jaws 26 of the electrical switch 22, e.g., securing the switch cover 28 to the switch 22.

The adjectives first, second, etc., are used throughout this document as identifiers and are not intended to signify importance, order, or quantity.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A method of insulating an electrical switch, comprising:
forming a switch cover having a front wall, a first side wall, a second side wall, a top wall, and an open bottom opposite the top wall by folding a sheet of electrically insulating material; and
placing the switch cover over a component of the electrical switch, the component extending into the switch cover through the open bottom.

2. The method of claim 1, wherein folding the sheet of electrically insulating material into the switch cover includes folding the sheet along a plurality of pre-formed fold lines.

3. The method of claim 2, wherein the plurality of pre-formed fold lines each include one of a perforated line, a scored line, or a crimped line.

4. The method of claim 1, wherein the switch cover formed by folding the sheet of electrically insulating material includes an extension wall extending from the front wall.

5. The method of claim 4, wherein the extension wall extends inwardly from the front wall.

6. The method of claim 4, wherein the extension wall extends outwardly from the front wall.

7. The method of claim 4, further comprising placing the extension wall between jaws of the electrical switch.

8. The method of claim 4, wherein the extension wall extends upward beyond the top wall.

9. The method of claim 4, wherein the extension wall includes a bottom edge and the front wall includes a bottom edge vertically spaced from the bottom edge of the extension wall.

10. The method of claim 1, wherein the top wall includes a first panel extending from the first side wall toward the second wall and a second panel extending from the second side wall toward the first side wall.

11. The method of claim 10, wherein the first panel includes a first engagement feature and the second panel includes a second engagement feature.

12. The method of claim 11, wherein forming the switch cover includes engaging the first engagement feature with the second engagement feature.

13. The method of claim 11, wherein the first engagement feature includes a tab and the second engagement feature includes a slot.

14. The method of claim 13, wherein forming the switch cover includes disposing the tab of the first engagement feature into the slot of the second engagement feature.

15. The method of claim 1, wherein the sheet of electrically insulating material includes a top edge, a bottom edge, a first pre-formed fold line extending from the top edge to the bottom edge and a second pre-formed fold line extending from the top edge to the bottom edge.

16. The method of claim 15, wherein the sheet of electrically insulating material includes a right edge, a left edge, a third pre-formed fold line extending from the left edge to the first pre-formed fold line, and a fourth pre-formed fold line extending from the right edge to the second pre-formed fold line.

17. The method of claim 16, wherein the sheet of electrically insulating material includes a fifth pre-formed fold line, a sixth pre-formed fold line, and a seventh pre-formed fold line, all extending from the top edge to the bottom edge and between the first pre-formed fold line and the second pre-formed fold line.

18. An assembly, comprising:
a switch block assembly having a plurality of switches; and
a switch cover formed from a folded sheet of electrically insulating material and supported by the switch block assembly, the switch cover enclosing a component of one of the switches.

19. The assembly of claim 18, wherein the one of the switches include jaws and the switch cover includes an extension wall disposed within the jaws.

20. The assembly of claim 19, wherein the switch cover defines a cavity, the component of one of the switches includes a toggle arm within the cavity, and wherein the extension wall disposed within the jaws is outside the cavity.
